(19) United States
(12) Patent Application Publication
(10) Pub. No.: US 2026/0241719 A1
(43) Pub. Date: Aug. 20, 2026

(54) PRINTING APPARATUS

(71) Applicant: CANON KABUSHIKI KAISHA, Tokyo (JP)

(72) Inventors: TAKASHI SASAKI, Kanagawa (JP); TAKESHI SEKINO, Kanagawa (JP); HIROSHI NAKAI, Kanagawa (JP); KENTO TAMARI, Saitama (JP); SHUICHI TOKUDA, Kanagawa (JP)

(21) Appl. No.: 19/532,489

(22) Filed: Feb. 6, 2026

(30) Foreign Application Priority Data
Feb. 17, 2025 (JP) 2025-023705

(51) Int. Cl. B41J 13/00; B41J 13/10; B41J 13/14

(52) U.S. Cl. CPC B41J 13/0036; B41J 13/0027; B41J 13/106; B41J 13/14

(57) ABSTRACT

A printing apparatus includes a printing unit configured to perform printing on a sheet; a sheet discharge portion configured to discharge the printed sheet; a discharge tray configured to stack the discharged sheet; an upper housing configured to be arranged on an upper side of the discharge tray; and a sheet guide rib configured to be arranged along a bottom surface of the upper housing to guide the discharged sheet. The discharge tray includes a concave portion at a position immediately under the sheet guide rib. The upper housing is configured to rotate in a depth direction of the printing apparatus.

### BACKGROUND

### Field of the Technology

The present disclosure relates to a printing apparatus.

### Description of the Related Art

In a printing apparatus such as an inkjet printer, an internal discharge configuration that discharges paper to the lower side of an image reading unit (scanner unit) is used for the purpose of saving space and reducing the size and thickness. When the discharge space is made narrow in consideration of the size of the printing apparatus, a sheet guide rib for preventing paper jam under the bottom surface of the scanner unit is arranged. The sheet guide rib is a member configured to suppress curling of paper.

To suppress curling of paper, the interval between the sheet guide rib and a discharge tray needs to be narrow to some extent. For this reason, the discharged paper extraction space is narrow. To ensure the discharged paper extraction space, Japanese Patent No. 6559811 proposes not to extend the length of the sheet guide rib up to the downstream end (the front surface of the printing apparatus).

However, the technique of Japanese Patent No. 6559811 cannot suppress curling of paper using the short sheet guide rib in a case where a curled sheet always moves along the upper surface. In an inkjet printing apparatus, particularly, curling of paper immediately after printing is very large, and jam may occur.

### SUMMARY

The present disclosure provides a technique of suppressing occurrence of jam and improving discharged paper extractability.

According to one aspect of the present disclosure, there is provided a printing apparatus comprising: a printing unit configured to perform printing on a sheet; a sheet discharge portion configured to discharge the printed sheet; a discharge tray configured to stack the discharged sheet; an upper housing configured to be arranged on an upper side of the discharge tray; and a sheet guide rib configured to be arranged along a bottom surface of the upper housing to guide the discharged sheet, wherein the discharge tray includes a concave portion at a position immediately under the sheet guide rib, and the upper housing is configured to rotate in a depth direction of the printing apparatus.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view showing the overall configuration of a printing apparatus 1 according to the first embodiment;

FIG. 1B is a view for explaining the internal configuration of the printing apparatus 1 according to the first embodiment;

FIG. 1C is a view for explaining a discharge tray 17 and a discharge tray 120 according to the first embodiment;

FIG. 2 is a sectional view showing the internal configuration of the printing apparatus 1 according to the first embodiment;

FIG. 3A is a view for explaining a discharged paper stacking portion according to the first embodiment;

FIG. 3B is a view of the discharged paper stacking portion viewed from the front of a main body portion;

FIG. 3C is a sectional view taken along a line B - B in FIG. 3B;

FIG. 4A is a perspective view showing a state in which a housing according to the first embodiment is open;

FIG. 4B is a side view showing a state in which the housing according to the first embodiment is open;

FIG. 5A is a view for explaining the positional relationship between a sheet guide rib 200 and a discharge tray 17 according to Example A;

FIG. 5B is a view for explaining the positional relationship between a sheet guide rib 200 and a discharge tray 17 according to Example B;

FIG. 6A is a view showing the overall configuration of a printing apparatus 1 according to the second embodiment; and

FIG. 6B is a view for explaining the internal configuration of the printing apparatus 1 according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

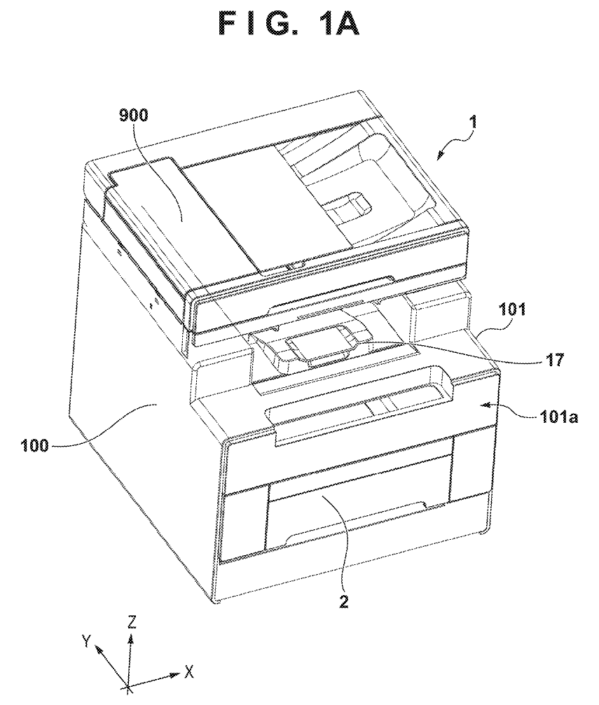

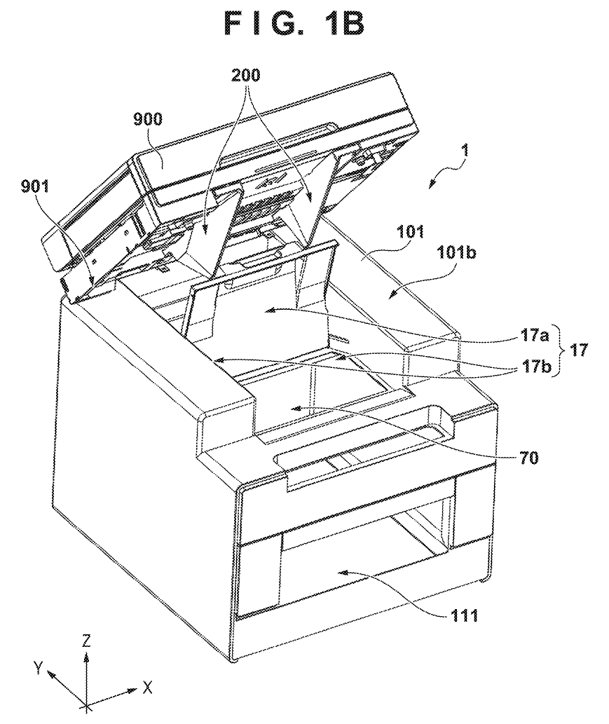

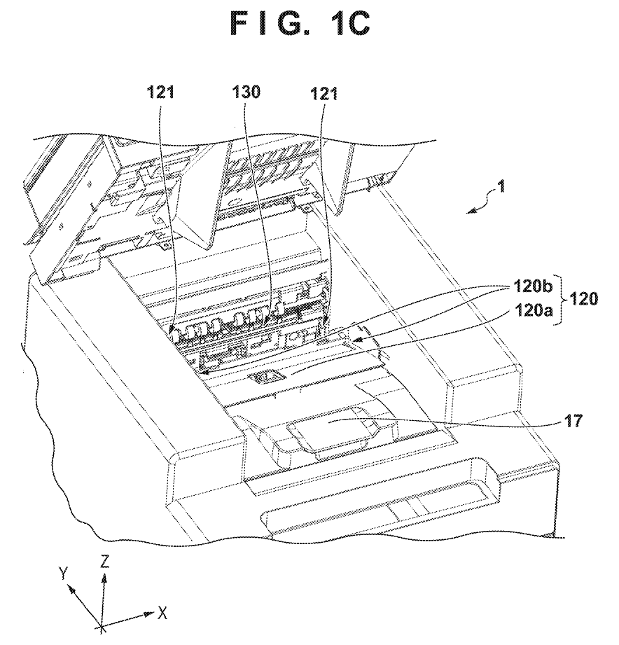

FIG. 1A is a perspective view showing the overall configuration of a printing apparatus 1 according to the first embodiment.

### Overall Configuration of Printing Apparatus 1

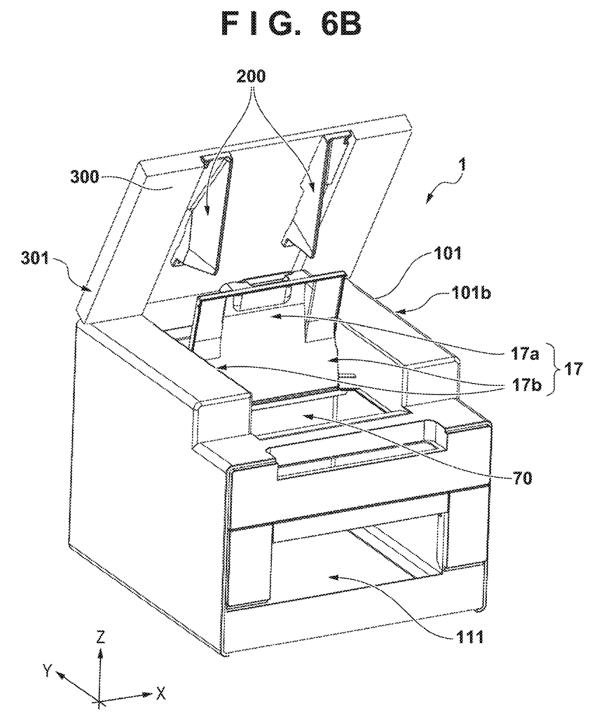

The printing apparatus 1 is an inkjet printer. The printing apparatus 1 includes a main body portion 100, a cassette 2, a discharge tray 17, and a discharge tray 120 (see FIG. 1C). The main body portion 100 is defined by a housing 101. The cassette 2, the discharge tray 17, and the discharge tray 120 are attached to the main body portion 100. A scanner unit 900 is provided as an upper housing on the upper side of the housing 101, but the present disclosure is not limited to this. A cover member 300 (see FIG. 6A) may be provided as an upper housing on the upper side of the housing 101. In this specification, "upper housing" is the scanner unit 900 or the cover member 300.

Here, to facilitate understanding of the structure, X, Y, and Z directions crossing (substantially orthogonal to) each other are shown in the drawings, and the same definition can be applied to drawings other than FIGS. 1A to 1C. The X direction corresponds to the left/right direction or widthwise direction. The Y direction corresponds to the front/rear direction or depth direction. The Z direction corresponds to the up/down direction or height direction. Note that the -X side is defined as the left side, and the +X side is defined as the right side. The -Y side is defined as the near side, and the +Y side is defined as the far side. The -Z side is defined as the lower side, and the +Z side is defined as the upper side. In the following explanation, however, if distinguishing between one side and the other side is unnecessary, these are simply referred to as the X, Y, and Z directions. Both the X and Y directions may be expressed as a horizontal direction. The Z direction may be expressed as a vertical direction.

FIG. 1B is a view for explaining the internal configuration of the printing apparatus 1 according to the first embodiment. FIG. 1C is a view for explaining the discharge tray 17 and the discharge tray 120 according to the first embodiment.

The scanner unit 900 is installed on the housing 101 such that it rotates in the Y direction with respect to a shaft portion 901 as a rotation shaft. In this specification, the upper housing (scanner unit 900) is configured to rotate in the depth direction (Y direction) of the printing apparatus 1. In addition, a sheet guide rib 200 is arranged along the bottom surface of the scanner unit 900 (upper housing) such that a discharged sheet is guided to the nearest side (-Y side) of the scanner unit 900 (upper housing). In this specification, the scanner unit 900 is a device that reads an image. The image is at least one of an image printed on paper by the printing apparatus 1 and an image printed on paper in advance.

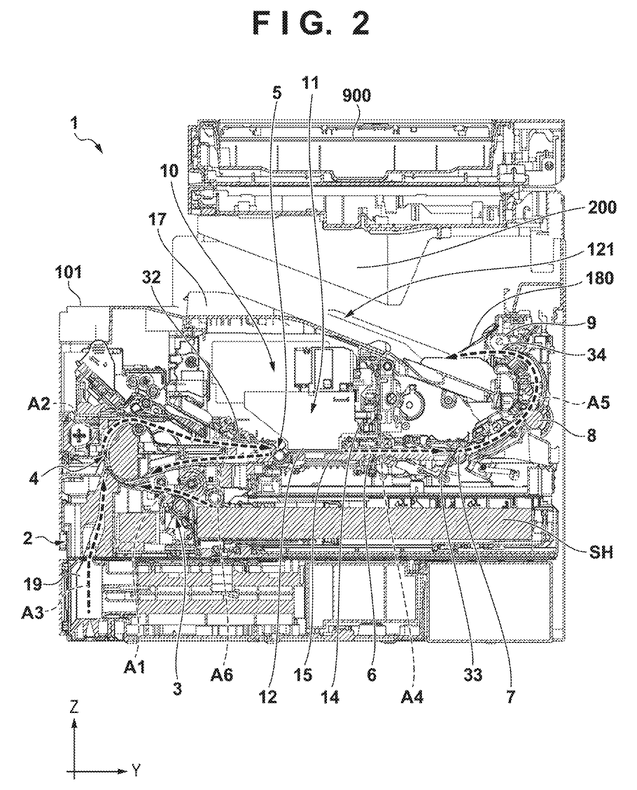

A slot 111 that stores the cassette 2 shown in FIG. 1A such that it can slide in the Y direction is provided on a front surface 101a of the main body portion 100. The cassette 2 can be inserted/removed into/from the slot 111. One or more sheets SH (see FIG. 2) are stacked and stored in the cassette 2. It suffices that the sheet SH is a sheet-shaped print medium of paper. A cut sheet having a size (for example, A4 size) complying with a predetermined standard is used as the sheet SH. The cassette 2 may be expressed as a sheet cassette or a storage cassette.

The discharge tray 17 and the discharge tray 120 are provided between an upper surface 101b of the main body portion 100 and the lower portion of the scanner unit 900. The printed sheet SH discharged to the outside of the main body portion 100 is placed on the discharge tray 17 or the discharge tray 120. The discharge tray 17 and the discharge tray 120 are each provided to seal the inside of the main body portion 100 such that it can be opened/closed. In a closed state of the main body portion 100, the discharge tray 17 is located on the -Y side with respect to the discharge tray 120 (see FIG. 1C).

The discharge tray 17 includes a plate-shaped member 17a and a shaft portion 17b (see FIG. 1B). The plate-shaped member 17a is axially rotatably supported by the shaft portion 17b at an end portion of the housing 101 on the +Y side. The discharge tray 17 can rotate with respect to the X direction as a rotation shaft. An opening 70 on the upper side of the housing 101 can thus be set in an open state (see FIG. 1B) or a closed state (see FIG. 1A).

In the closed state of the opening 70 (see FIG. 1A), the plate-shaped member 17a forms a substantially horizontal surface on the -Y side and forms a tilting surface on the +Y side. The tilting surface of the plate-shaped member 17a tilts such that the +Y side is low and the -Y side is high.

The discharge tray 120 includes a plate-shaped member 120a and shaft portions 120b (see FIG. 1C). The shaft portions 120b are provided at two end portions (two side portions) of the plate-shaped member 120a in the X direction. On a wall portion of the housing 101 facing each shaft portion 120b, a guiderail 121 is extended along the tilting surface of the plate-shaped member 17a in the closed state. The shaft portion 120b slidably engages with the guiderail 121.

The discharge tray 120 can thus slide to above the tilting surface of the discharge tray 17 in the closed state. An opening 130 on the upper side of the housing 101 can be set in an open state (see FIG. 1C) or a closed state (see FIG. 1A).

Note that the opening 70 and the opening 130 may be integrally formed on the upper side of the housing 101. Here, to facilitate understanding, the portion that is opened by rotation of the discharge tray 17 is the opening 70. The portion that is opened by sliding of the discharge tray 120 is the opening 130.

After the scanner unit 900 is set in the open state, a user rotates the discharge tray 17 or slides the discharge tray 120, thereby relatively easily exposing the inside of the main body portion 100 to an open state. The user can thus visually recognize the inside of the main body portion 100 through the opening 70 or the opening 130 and access the inside of the main body portion 100.

In this way, the discharge tray 17 and the discharge tray 120 each function as a placement portion on which the printed sheet SH discharged to the outside of the main body portion 100 is placed, and further function as a cover portion that seals the inside of the main body portion 100 such that it can be opened/closed. Hence, both the discharge tray 17 and the discharge tray 120 may be expressed as a discharge tray cover. Alternatively, to distinguish the two discharge trays, the discharge tray 17 may be expressed as a rotation type cover. The discharge tray 120 may be expressed as a slide type cover.

### Internal Structure of Printing Apparatus 1

FIG. 2 is a sectional view showing the internal configuration of the printing apparatus 1 according to the first embodiment.

The printing apparatus 1 further includes, inside the main body portion 100, a printing unit 10, a driving unit 14, a platen 15, a plurality of conveyance units 3 to 9, a plurality of sensors 32 to 34, and a flapper 180.

The printing unit 10 includes a carriage 11 and a printhead 12. In this specification, the printing unit 10 is a unit that prints an image on a sheet SH. The carriage 11 is configured to be reciprocally movable in the X direction with the printhead 12 mounted thereon. The printhead 12 can thus scan in the X direction. A plurality of nozzles are arrayed on the surface of the printhead 12 facing the platen 15. Each nozzle discharges ink supplied from an ink tank (not shown) via an ink tube.

The driving unit 14 drives the printing unit 10. The driving unit 14 includes a traveling belt configured to reciprocally move the carriage 11, a pulley configured to make the traveling belt travel, and an electric motor configured to drive the pulley.

Thus, the driving unit 14 reciprocally moves the carriage 11 to make the printhead 12 scan when the sheet SH is passing between the printhead 12 and the platen 15. The driving unit 14 drives the printhead 12 to cause each nozzle to discharge ink. Printing on the sheet SH is thus performed.

Here, "print" indicates forming an image by discharging ink to the sheet SH. The concept of "image" includes a character, a number, a symbol, a graphic, a photo, and the like, and whether these are visible or not does not matter. Ink is, typically, a liquid containing dyes and pigments but it may be a colorless and transparent reaction liquid. These may be comprehensively expressed as a liquid. In this viewpoint, the printing apparatus 1 may be expressed as a liquid discharge apparatus. In addition, the printhead 12 may be expressed as a liquid discharge head.

In this embodiment, printing on the sheet SH is implemented by alternately performing an operation (intermittent conveyance) of conveying the sheet SH by only a predetermined distance and then suppressing the conveyance and an operation (print scanning) of causing the printhead 12 to scan to perform printing during suppression of the conveyance. The printhead 12 is also expressed as a serial head. As another embodiment, the printhead 12 may be a line head capable of printing the whole region of the sheet SH in the widthwise direction at once.

Each of the conveyance units 3 to 9 is arranged at a corresponding position along the conveyance path (indicated by a broken arrow) of the sheet SH. A driving roller rotates with the sheet SH sandwiched by it and a driven roller or a driven spur, thereby conveying the sheet SH. The driven roller is located on the side of the surface of the sheet SH before printing, on which printing should be performed. The driven spur is located on the side of the surface of the printed sheet SH on which printing was performed. Each of the driven roller and the driven spur is arranged while being biased with respect to the driving roller by a biasing means (not shown) such that it can rotate and abut against the corresponding driving roller.

The conveyance unit 3 includes a driving roller and a driven roller, which abut against each other. The conveyance unit 3 conveys the sheet SH picked up from the cassette 2 (see an arrow A1). The conveyance unit 4 includes a driving roller and a driven roller, which abut against each other, like the conveyance unit 3, and further conveys the sheet SH conveyed from the conveyance unit 3 (see an arrow A2).

Note that the conveyance unit 4 can receive the sheet SH from an external paper feeding unit 19 additionally attached to the lower side of the main body portion 100 and convey it (see an arrow A3).

The conveyance unit 5 and the conveyance unit 6 can execute intermittent conveyance and conveyance at a constant speed. The conveyance unit 5 is arranged on the upstream side with respect to the printing unit 10 in the conveyance direction. The conveyance unit 5 includes a driving roller and a driven roller, which abut against each other. The conveyance unit 5 intermittently conveys the sheet SH toward the printing unit 10.

Also, the conveyance unit 6 is arranged on the downstream side with respect to the printing unit 10 in the conveyance direction. The conveyance unit 6 includes a driving roller and a driven spur, which abut against each other. The conveyance unit 6 intermittently conveys the sheet SH printed by the printing unit 10 further to the downstream side (see an arrow A4).

Each of the conveyance units 7 to 9 includes a driving roller and a driven spur, which abut against each other. The conveyance units 7 to 9 are arranged along a discharge path (or a discharge conveyance path) for discharging the printed sheet SH conveyed from the conveyance unit 6 outside the main body portion 100. That is, the discharge path indicates the path from the conveyance unit 6 to the conveyance unit 9, through which the sheet SH can pass, in the conveyance path of the sheet SH (indicated by the arrow A1, and the like).

The discharge path includes a curved discharge path (see an arrow A5) in the path from the rear side of the lower portion in the main body portion 100 to the rear side of the upper portion. The sheet SH is reversed such that its printed surface faces down and discharged to the discharge tray 17 or the discharge tray 120. Such a discharge mode is called "face-down discharge".

In the curved discharge path, the conveyance unit 7 is located at the lowermost position. The conveyance unit 8 is located at the rearmost position. The conveyance unit 9 is located at the uppermost position. The conveyance units 7 to 9 can thus be distinguished from each other.

In the conveyance units 6 to 9 arranged on the downstream side of the printing unit 10, the driven spur is arranged on the side of the printed surface of the sheet SH, and the driving roller is arranged on the side opposite to the printed surface of the sheet SH.

Note that for the sake of distinguishing them, the conveyance units 3 to 9 may be expressed using other names in accordance with the purpose, the application, the arrangement position, and the like. For example, the conveyance unit 3 and the conveyance unit 4 may each be expressed as a paper feeding unit. The conveyance units 7 to 9 may each be expressed as a discharge unit. In this specification, a sheet discharge portion is a member that discharges a sheet printed by the printing unit 10 and indicates the conveyance units 7 to 9.

The sensors 32 to 34 are configured to be able to detect the presence/absence of the sheet SH. The sensors 32 to 34 detect, for example, passage of the leading edge (downstream side end) of the sheet SH and the trailing edge (upstream side end). As each of the sensors 32 to 34, a known optical sensor is typically used.

The sensor 32 is arranged on the upstream side of the printing unit 10 (in this embodiment, on the upstream side of the conveyance unit 5).

The sensor 33 is arranged on the downstream side of the printing unit 10 (in this embodiment, on the downstream side of the conveyance unit 6 and near the conveyance unit 7).

The sensor 34 is arranged on the downstream side of the curved discharge path (in this embodiment, near the conveyance unit 9). This makes it possible to specify the position of the sheet SH as the conveyance target.

A case where the printing apparatus 1 prints only one surface of the sheet SH has been described. The printing apparatus 1 can further print the surface on the side opposite to the printed surface of the sheet SH (so-called double-sided printing is possible). The sheet SH with only one surface printed is conveyed halfway through the curved discharge path. After that, the sheet SH is returned by the conveyance units 5 to 9 to the conveyance unit 4 through the printing unit 10 and then reversed when returned to the conveyance unit 4 (see an arrow A6). The sheet SH is conveyed to the printing unit 10 again, and printing on the other surface of the sheet SH is performed.

### Relationship between Discharge Tray and Sheet Guide Rib

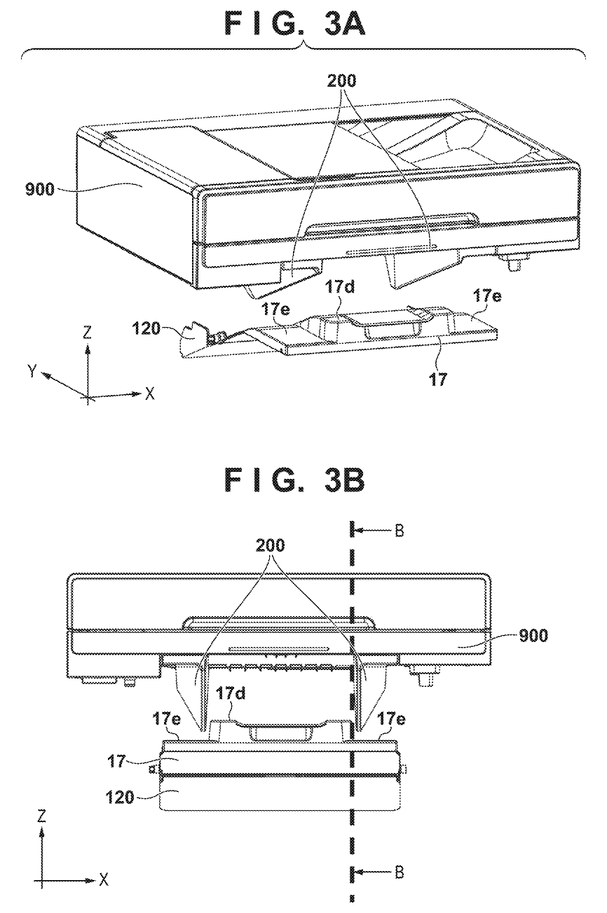

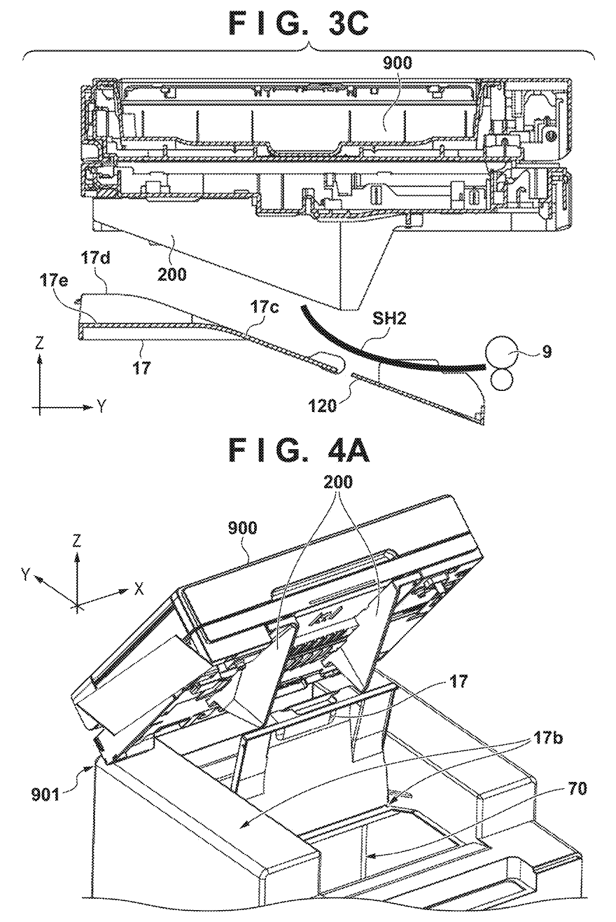

FIG. 3A is a view for explaining a discharged paper stacking portion according to the first embodiment. FIG. 3B is a view of the discharged paper stacking portion viewed from the front of the main body portion. FIG. 3C is a sectional view taken along a line B - B in FIG. 3B. As described above, the discharge tray 17 and the discharge tray 120 are arranged on the lower side of the scanner unit 900. The sheet guide rib 200 is arranged on the bottom surface of the scanner unit 900.

The sheet guide rib 200 can suppress curling of a sheet SH2 to be discharged. Here, if the sheet guide rib 200 is not arranged, the curled sheet SH2 hits the bottom surface of the scanner unit 900, and the sheet SH2 readily jams. The sheet guide rib 200 is preferably parallel to the discharge tray 17 and the discharge tray 120 when viewed on the YZ section.

Also, the front surface portion of the discharge tray 17 includes a tilting surface 17c parallel to the sheet guide rib 200, and a substantially horizontal surface 17d having a small angle with respect to the XY horizontal surface. In this specification, the discharge tray 17 includes at least the tilting surface 17c parallel to the sheet guide rib 200, and the substantially horizontal surface 17d. In the configuration of the discharge tray 17, the distance between the scanner unit 900 and the discharged paper stacking surface is larger than in a configuration in which the tilting surface 17c continues up to the frontmost surface of the discharge tray 17. For this reason, extractability of stacked discharged sheets improves.

Additionally, the front surface portion of the discharge tray 17 immediately under the sheet guide rib 200 in the Z direction has a shape bending to a surface 17e under the substantially horizontal surface 17d in the Z direction. Thus, even if the sheet guide rib 200 extends up to the front surface of the discharge tray 17, a space can be ensured between the sheet guide rib 200 and the discharge tray 17. For this reason, extractability of stacked discharged sheets improves.

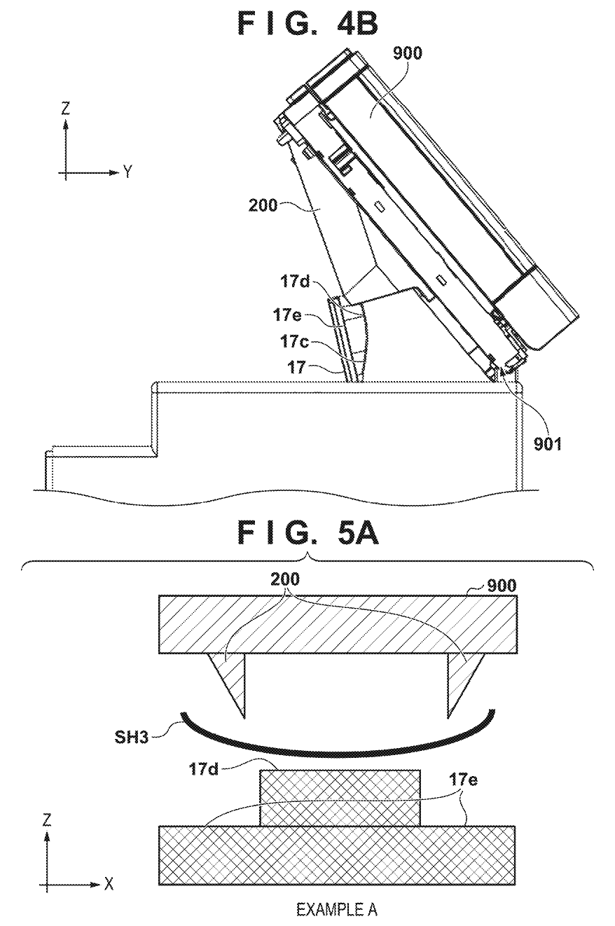

FIG. 4A is a perspective view showing a state in which the housing according to the first embodiment is open. FIG. 4B is a side view showing a state in which the housing according to the first embodiment is open. In FIGS. 4A and 4B, the scanner unit 900 rotates about the shaft portion 901 in the Y direction, and the discharge tray 17 rotates about the shaft portion 17b. In this specification, the scanner unit 900 (upper housing) is configured to rotate in the Y direction (the depth direction of the printing apparatus 1). The discharge tray 17 is configured to rotate in the same direction (Y direction) as the scanner unit 900 (upper housing). The housing 101 thus takes the open state (a state in which the opening 70 is visible).

At this time, the sheet guide rib 200 and the discharge tray 17 overlap in the X direction (see FIG. 4B). In this specification, if the discharge tray 17 and the scanner unit 900 (upper housing) rotate to a predetermined position in the Y direction (the depth direction of the printing apparatus 1), the sheet guide rib 200 and the discharge tray 17 overlap in the X direction (the widthwise direction of the printing apparatus 1). In other words, the sheet guide rib 200 and the discharge tray 17 are arranged linearly in the Z direction (the height direction of the printing apparatus 1). This can make the opening angle of the scanner unit 900 small when opening the opening 70. For this reason, even if the printing apparatus 1 is installed in a narrow installation range (a space or place where the height in the Z direction is low), the user can perform maintenance of the printing apparatus 1.

Also, in the operation of closing the scanner unit 900, the sheet guide rib 200 comes into contact with the surface 17e of the discharge tray 17. In this specification, after the sheet guide rib 200 contacts the surface 17e (concave portion) of the discharge tray 17 at a predetermined position in the Y direction (the depth direction of the printing apparatus 1), the discharge tray 17 rotates in synchronism with rotation for closing the scanner unit 900 (upper housing). For this reason, the user can close the scanner unit 900 and the discharge tray 17 simultaneously by one operation of closing the scanner unit 900. This improves the convenience for the user.

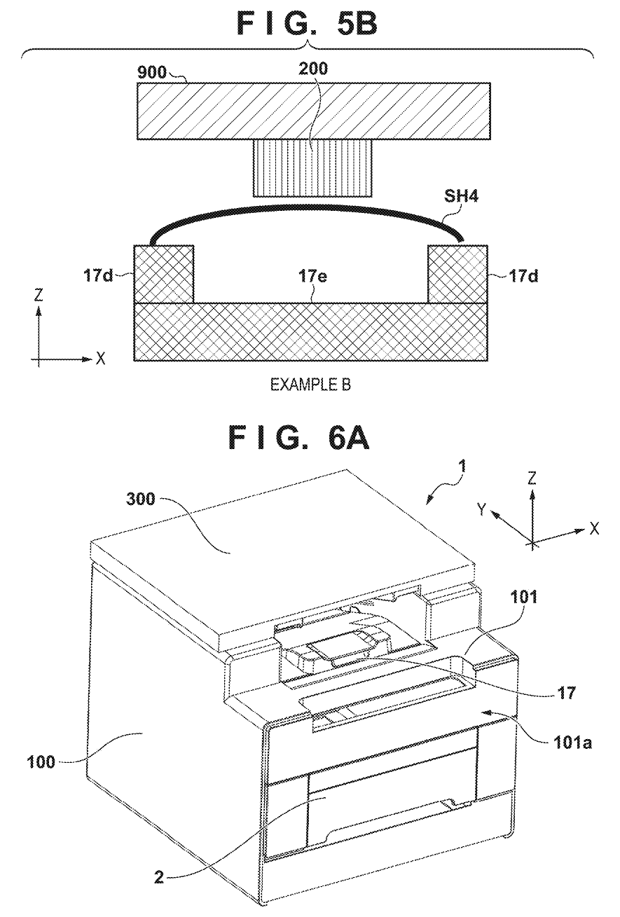

FIG. 5A is a view for explaining the positional relationship between a sheet guide rib 200 and a discharge tray 17 according to Example A. Note that FIG. 5A is a view of a printing apparatus 1 viewed from the front.

Example A indicates the optimum arrangement of a sheet guide rib 200 and a discharge tray 17 in a case where a sheet SH3 curls in a shape projecting downward. For example, Example A can be applied when the printing method is an inkjet method and face-down discharge in which a printed surface is located on the lower side in the Z direction is performed. The sheet guide ribs 200 are arranged at the two end portions of the sheet SH3 in the widthwise direction. Here, to distinguish the two sheet guide ribs 200, the sheet guide rib 200 on the left side in FIG. 5A is called "sheet guide rib", and the sheet guide rib 200 on the right side is called "another sheet guide rib". In this specification, the sheet guide rib 200 (the other sheet guide rib) on the right side is arranged in parallel to the sheet guide rib 200 (sheet guide rib) on the left side on the bottom surface of a scanner unit 900 (upper housing). The sheet guide rib 200 (sheet guide rib) on the left side guides the left side portion of the sheet SH3 in the widthwise direction (X direction) of the sheet SH3. On the other hand, the sheet guide rib 200 (the other sheet guide rib) on the right side guides the right side portion of the sheet SH3 in the widthwise direction (X direction) of the sheet SH3. In this specification, the interval between the sheet guide rib 200 on the left side and the sheet guide rib 200 (the other sheet guide rib) on the right side in FIG. 5A is preferably 100 mm or more. A substantially horizontal surface 17d of the discharge tray 17 is located at the center of the width of the sheet SH3. Two surfaces 17e are arranged immediately under the sheet guide ribs 200 in the Z direction at the two end portions of the width of the sheet SH3. Here, to distinguish the two surfaces 17e, the surface 17e on the left side in FIG. 5A is called a "concave portion", and the surface 17e on the right side is called "another concave portion". In this specification, the surface 17e is called a "concave portion" that is located immediately under the sheet guide rib 200 located on the nearest side of the scanner unit 900 (upper housing) in the sheet guide rib 200. Here, the substantially horizontal surface 17d with respect to the "concave portion" may be called a "convex portion". The XZ sectional shape of the sheet guide rib 200 is preferably a V shape in accordance with the curl shape of the sheet SH3, but the present disclosure is not limited to this. In this specification, the sectional shape (XZ sectional shape) of the sheet guide rib 200 in the widthwise direction (X direction) of the sheet SH3 is a tapered shape that becomes thinner toward the distal end and is preferably a V shape.

FIG. 5B is a view for explaining the positional relationship between a sheet guide rib 200 and a discharge tray 17 according to Example B. Note that FIG. 5B is a view of a printing apparatus 1 viewed from the front.

Example B indicates the optimum arrangement of a sheet guide rib 200 and a discharge tray 17 in a case where a sheet SH4 curls in a shape projecting upward. For example, Example B can be applied when the printing method is an inkjet method and face-up discharge in which a printed surface is located on the upper side in the Z direction is performed. The sheet guide rib 200 is arranged at the center portion of the sheet SH4 in the widthwise direction. In this specification, the sheet guide rib 200 guides the center portion of the sheet SH4 in the widthwise direction (X direction) of the sheet SH4. The sectional shape (XZ sectional shape) of the sheet guide rib 200 in the widthwise direction (X direction) of the sheet SH4 is a rectangular shape but may be a tapered shape or V shape similar to Example A. Substantially horizontal surfaces 17d of the discharge tray 17 are located at the two end portions of the width of the sheet SH4. A surface 17e is arranged immediately under the sheet guide rib 200 in the Z direction at the center portion of the width of the sheet SH4. In this specification, the surface 17e is called a "concave portion" that is located immediately under the sheet guide rib 200 located on the nearest side of a scanner unit 900 (upper housing) in the sheet guide rib 200. Here, the substantially horizontal surface 17d with respect to the "concave portion" may be called a "convex portion".

### Second Embodiment

FIG. 6A is a view showing the overall configuration of a printing apparatus 1 according to the second embodiment. FIG. 6B is a view for explaining the internal configuration of the printing apparatus 1 according to the second embodiment. The same reference numerals as in the first embodiment are added to the same components in FIGS. 6A and 6B and a description thereof will be omitted.

### Overall Configuration of Second Embodiment

In the first embodiment, the scanner unit 900 is provided on the upper side of the housing 101, but the present disclosure is not limited to this. For example, in the second embodiment, a cover member 300 is arranged as an upper housing on the upper side of a housing 101. Note that the rest of the configuration of the second embodiment is the same as the configuration of the first embodiment, and a detailed description thereof will be omitted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-023705, filed February 17, 2025, which is hereby incorporated by reference herein in its entirety.

What is claimed is:

1. A printing apparatus comprising:
a printing unit configured to perform printing on a sheet;
a sheet discharge portion configured to discharge the printed sheet;
a discharge tray configured to stack the discharged sheet;
an upper housing configured to be arranged on an upper side of the discharge tray; and
a sheet guide rib configured to be arranged along a bottom surface of the upper housing to guide the discharged sheet,
wherein the discharge tray includes a concave portion at a position immediately under the sheet guide rib, and
the upper housing is configured to rotate in a depth direction of the printing apparatus.

2. The apparatus according to claim 1, wherein
the upper housing is a scanner unit or a cover member.

3. The apparatus according to claim 1, further comprising another sheet guide rib arranged in parallel to the sheet guide rib on the bottom surface of the upper housing,
wherein the sheet guide rib guides a left side portion of the sheet in a widthwise direction of the sheet,
the other sheet guide rib guides a right side portion of the sheet in the widthwise direction of the sheet, and
the discharge tray further includes another concave portion at a position immediately under the other sheet guide rib.

4. The apparatus according to claim 3, wherein
an interval between the sheet guide rib and the other sheet guide rib is not less than 100 mm.

5. The apparatus according to claim 1, wherein
the sheet guide rib guides a center portion of the sheet in a widthwise direction of the sheet,

6. The apparatus according to claim 1, wherein
the discharge tray is configured to rotate in the same direction as the upper housing.

7. The apparatus according to claim 6, wherein
in a case where the discharge tray and the upper housing rotate to a predetermined position, the sheet guide rib and the discharge tray overlap in a widthwise direction of the printing apparatus.

8. The apparatus according to claim 7, wherein
after the sheet guide rib contacts the concave portion of the discharge tray at the predetermined position, the discharge tray rotates in synchronism with rotation for closing the upper housing.

9. The apparatus according to claim 1, wherein
the discharge tray includes a tilting surface parallel to the sheet guide rib, and a substantially horizontal surface.

10. The apparatus according to claim 3, wherein
a sectional shape of the sheet guide rib and the other sheet guide rib in the widthwise direction of the sheet is a tapered shape.

11. The apparatus according to claim 3, wherein
a sectional shape of the sheet guide rib and the other sheet guide rib in the widthwise direction of the sheet is a V shape.

12. The apparatus according to claim 1, wherein
a sectional shape of the sheet guide rib in the widthwise direction of the sheet is a rectangular shape.

13. The apparatus according to claim 1, wherein
the printing apparatus is an inkjet printer.
